(19) United States
(12) Patent Application Publication
(10) Pub. No.: US 2005/0274731 A1
(43) Pub. Date: Dec. 15, 2005

(54) Refillable article storage device

(75) Inventors: Munroe Chirnomas, Morris Township, NJ (US); Raymond B. Leski, Toms River, NJ (US)

Correspondence Address: LAWRENCE C. EDELMAN, IP COUNSEL FASTCORP, 60 E. HANOVER AVE, B-2, MORRIS PLAINS, NJ, 07950, US

(73) Assignee: Munroe Chirnomas

(21) Appl. No.: 10/865,383

(22) Filed: Jun. 9, 2004

(51) Int. Cl. G07F 11/66; G07F 11/00; B65G 59/00; B65H 3/00; B65H 1/08; G07F 11/16

(52) U.S. Cl. 221/114; 221/232

(57) ABSTRACT

An article handling apparatus having a article storage area includes a removable article storage structure adapted for being positioned therein. The removable article storage structure comprises an elongate article storage bin having, for example, a rectangular cross-section. One sidewall of the bin includes an elongate article-loading opening therein. At least two elongate flaps are provided for closing the opening, a first flap that is hinged along a first longitudinal edge of the opening, and a second flap that is hinged along a second longitudinal edge of the opening and opposed to the first longitudinal edge. Closure of the flaps over the opening results in overlap of the distal ends of the flaps, and therefore a complete closing of the opening. Such complete closing of the opening also presents smooth surfaces along the inside surfaces of the bin to the stored articles. The smooth surfaces function to unobtrusively guide the stored articles out of the bin during a dispensing operation.

### BACKGROUND OF THE INVENTION

1. Field of the Invention

The present invention relates generally to improvements in the design and operation of an article storage area adapted for use with an article handling apparatus, such as a vending machine, as well as methods and systems useful therewith. The invention is particularly useful for transporting, storing and/or handling articles positioned or to be positioned in a columnar/stacked manner, and in some embodiments is particularly useful for handling and dispensing of fragile articles, such as bags of potato chips. The methods and apparatus of the invention provide for quick, accurate and reliable filling of the article storage area of the article handling apparatus, and are particularly advantageous when a large number of articles are required to be handled.

2. Background Information and Description of the Related Art

Most prior art article handling mechanisms, more specifically referred to in the description of the present invention as being in the environment of a point-of-sale (POS) article dispenser, rely on a multitude of motors, switches and solenoids for moving various portions of the handling mechanism, and handling of the articles themselves, such as packaged products. Most such machines require one motor, switch and/or solenoid dedicated for each row, column or type of article or package to be handled or dispensed therefrom. Such machines generally suffer from numerous disadvantages, such as poor reliability due to mechanical failures, as well known by those skilled in this art.

U.S. Pat. No. 5,240,139 represents a significant improvement in article handling devices. It describes the use of a negative air pressure lifter (i.e., article pickup or handling mechanism), which uses suction, i.e., a reduced or so-called “negative” air pressure created by a partial vacuum, for making a secure contact to an article to be retrieved by entering the open top of an article storage bin located in a refrigerated storage area of a vending machine. Although robotic, and specifically suction-type lifting mechanisms are in common use in factory settings, where space limitations are generally relaxed, their use in tight confines, such as an article vending machine, has not gained wide acceptance. Due to the greater reliability and versatility of vending machines of the type which utilizes suction technology for grasping and moving selected articles, it would be desirable to develop new techniques and methods for the operation and control of such machines, as well as for other more generalized article handling mechanisms.

Article storage is provided in the forenoted U.S. Pat. No. 5,240,139 by arranging a plurality of vertically aligned storage compartments or bins within the freezer. Since the articles to be dispensed were frozen, the weight presented on the articles stored in a lower portion of the bin, by the stack of articles stored above, did not present the problem of product crushing. In some applications, however, the articles stored in the bins may be fragile (such as potato chips which are packaged in flexible bags), and means would then be necessary to prevent crushing of the articles stored near the bottom of the bin. Even if article storage in the dispenser used horizontal placement of the article storage bins, fragile articles could still be damaged during transportation of the storage bins (which are filled with the fragile articles) from the warehouse or article manufacturer to the actual dispenser mechanism. It is desirable to make the article storage bins so that they have the most capacity possible, for example, by making the bins taller. However, the taller the article storage bins, the more the above noted crushing problem is exacerbated.

Furthermore, when the article storage bins store product which is date sensitive, i.e. which may get stale with the passage of time, it would be desirable to provide means which would ensure that refilling/filling of empty or partially empty bins is not only accomplished in a simple and reliable manner, but in a manner which preserves the filling order of the product in the bins, i.e. in a manner which maintains a FIFO (first in, first out) dispensing order. FIFO removal of the product from the article storage bins helps to insure the quality of the product dispensed to the consumer. It is noted, however, that when taller, higher capacity, bins are used, maintaining a FIFO requirement during refilling is exacerbated. This is because dispensing occurs from the open top of the bin, and therefore access to the interior of the bin for refilling/filling must be provided at an end of the bin which is opposite from the dispensing end, i.e., at the bottom of the bin. Furthermore, each bin must be individually handled for refilling.

Prior PCT patent publication WO 02/01525 (PCT Application PCT/US01/16847, Titled “METHOD AND APPARATUS FOR STORING ARTICLES FOR USE WITH AN ARTICLE HANDLING DEVICE”), incorporated herein by reference, describes the use of a “macrobox” for simultaneously moving a plurality of article storage bins, thereby facilitating the handling of articles to be vended from the storage area of a vending machine, as well as the use of bin segments for facilitating a more rapid and trouble free re-loading of individual ones of the article storage bins, which helps insure FIFO article reloading. Additionally describe in this publication are article supporting tabs which line opposed walls inside the bin. These tabs are useful to support the weight of the articles positioned inside the bin, and are biased so as to obstruct the movement of the articles in the downward direction inside the bin, but not obstruct the movement of the articles in the upward direction inside the bin. Thus, these tabs also help encourage FIFO reloading of the bins.

PCT patent publication WO 02/01525 illustrates such a vending machine, which machine could also, for example, be modified/changed so as to take advantage of the bin arrangements described for the present invention. Accordingly, FIGS. 1-3 of this PCT patent publication and it's description are now provided as FIGS. 1-3 herein, for describing the structure and basic operation of the vending machine embodiment/environment for the article storage bins of the present inventions. After this description, and that of another prior art bin, details relating to the present invention are provided.

### OBJECTS OF THE INVENTION

It is desirable to provide a method and apparatus which improves upon the article storage bin techniques disclosed in PCT patent publication WO 02/01525.

### BRIEF SUMMARY OF THE INVENTION

In accordance with one aspect of the present invention, an article handling apparatus having an article storage area includes a removable article storage structure adapted for being positioned therein. The removable article storage structure comprises an elongate article storage bin having, for example, a rectangular cross-section. One sidewall of the bin includes an elongate article-loading opening therein. At least two elongate flaps are provided for closing the opening, a first flap hinged along a first longitudinal edge of the opening, and a second flap hinged along a second longitudinal edge of the opening which is opposed to the first longitudinal edge. A reusable latch closure arrangement is also provided, preferably by simple cut-outs in the sheet material used to form the article storage bin.

During a filling operation, the two elongate flaps are initially opened so as to reveal the article-loading opening. The bin is then loaded with articles by inserting the articles into the bin using the article-loading opening. In a preferred embodiment the article-loading opening is formed in a lower portion of one side of the bin, in which case, during loading, it may be necessary to push the previously inserted, but as yet not dispensed articles, toward a top portion of the bin in order to make room for a sufficient amount of articles to completely fill the bin. Once a sufficient amount of articles have been loaded into the bin, the opening is closed by folding the first flap so as to at least partially cover the width of the opening, and then closing the second flap so as to overlap at least a portion of the width of the first flap, thereby completely covering the width of the opening. In a preferred embodiment, the length of the flaps is substantially the same as the length of the opening, so that when the flaps are closed over the article-loading opening, they present to the stored articles smooth surfaces at the edges of the article-loading opening, not only along the inside corners of the bin, but also along the side there-between. These smooth surfaces function to unobtrusively guide the stored articles along the interior and then out the top of the bin during a dispensing operation. Furthermore, the opening is formed in a side of the bin so as to leave a substantial portion of the top and bottom of the bin without an opening, thereby retaining structural integrity and rigidity for the bin. If the length of flaps are sized to just fit inside the opening, then the structural integrity and rigidity of the bin is improved even further.

### BRIEF DESCRIPTION OF THE FIGURES

FIG. 1 is a front perspective view of a vending machine constructed and operating in accordance with the principles of the invention.

FIG. 2 is front perspective view of the vending machine of FIG. 1, with the front door open, so as to illustrate the main mechanical and electrical components therein.

FIG. 3, illustrates the interior of the vending machine of FIG. 1, with certain wall portions shown cut-away to aid visualization.

FIGS. 4 and 5 illustrate refilling of two different types of prior art article storage bins with articles to be dispensed.

FIG. 6 illustrates an isometric view article storage bin constructed in accordance with the principles of the present invention.

FIG. 7a illustrates a plane view of sheet material having cutouts and creases positioned therein for making the article storage bin shown in FIG. 6, and

FIGS. 7b and 7c illustrate a top view of the article storage bin shown in FIG. 6, with the flaps shown in the open, and then closed, position.

### DETAILED DESCRIPTION OF PREFERRED EMBODIMENTS OF THE INVENTION

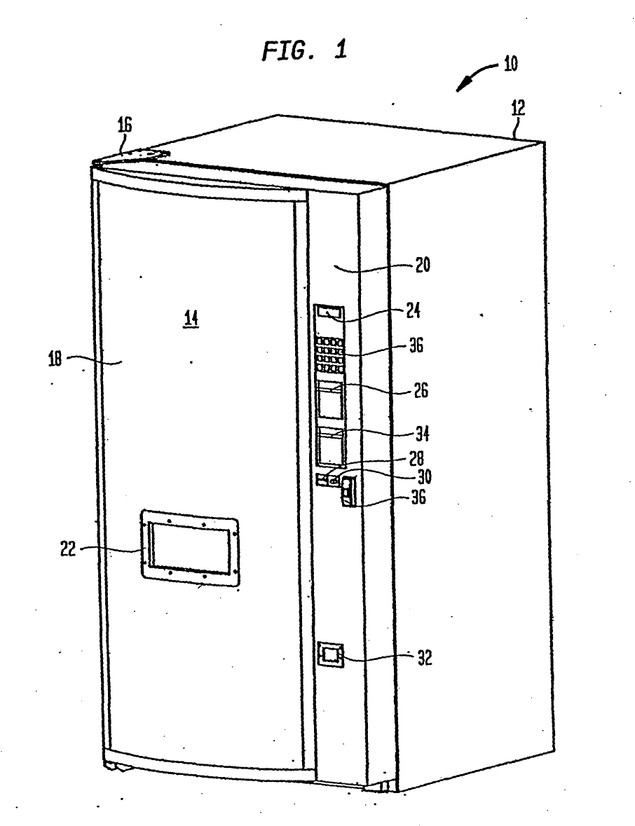

As noted above, the following text describes a preferred environment for article storage bins of the present invention. FIG. 1 illustrates as an environment of the invention described herein, an article merchandiser, such as a point-of-sale (POS) article dispenser. Although throughout the following description, reference is made to implementation of the invention in a vending machine environment, it is intended that the term “vending machine”, and in fact the environment of the present invention, include more general purpose article merchandising, handling, retrieval and/or dispensing apparatus, as well as POS equipment. Such equipment, if embodied as a portable device may comprise and be about the size of a traditional vending machine or as large as a tractor-pulled trailer, and if embodied as a non-portable device may comprise an automated dispensing room or an area located in a permanent structure, such as in a building (with or without interior walls and in some embodiments without an enclosing cabinet). Such an automated dispensing room could be easily constructed using the article dispensing mechanism and article storage techniques as described herein. For example, the article dispensing mechanism can be mounted on the ceiling of the room, and the entrance door into the room can be replaced with a door having features similar to the vending machine door described herein. The article storage bin arrangement and techniques of the present invention can be used to store the articles to be dispensed on the floor in the room. It is also noted that throughout the following description similar reference numerals used in the subsequent Figures are intended to refer to the same feature, element or part previously described.

Accordingly, FIG. 1 illustrates a perspective view of a vending machine 10, comprising one embodiment for an apparatus that is constructed and operates according to the present invention. Vending machine 10 includes a main cabinet 12 and a front door 14 mounted on a hinge 16 for providing access to the interior of the vending machine for servicing (refilling it with articles, maintenance, etc.), such refilling using the methods and apparatus of the inventions to be described. Note, in a further vending machine embodiment, a service door or access port to the interior of cabinet 12 could be positioned anywhere on or as a part of cabinet 12. In FIG. 1, front door 14 is shown in a closed position, forming an enclosure with main cabinet 12, the interior of which various components of vending machine 10 are housed, as explained in more detail below.

Front door 14 includes a convex-shaped display face panel 18 (commonly referred to as a “bubble” front); adjacent a flat section 20, however, these particular shapes are not necessary for the invention. For example, convex shaped display face panel 18 could be flat. Display face panel 18 is attached to the front of door 14 via a perimeter frame 9 of conventional design. In the illustrated embodiment the display face panel 18 is back-lit using fluorescent bulbs, not shown, to enhance the visibility of its graphics, and may therefore comprises a translucent plastic base material, such as LEXAN® or similar polycarbonate, having a thickness of, for example 0.115 inches. Display panel 18 typically has brand name and/or logo graphics pre-printed or screened on an interior facing side thereof, and may even include graphics which illustrate the individual articles that are vendible by vending machine 10, as well as the price and/or selection information for the articles.

A customer retrieval area 22 is formed in the panel 18 on door 14 so that articles stored therein can be discharged to a user of vending machine 10. In a further embodiment, area 22 can be formed on flat section 20, or another wall of cabinet 12.

Various user interface components are mounted on flat section 20 of door 14. A customer display 24 may be a conventional fluorescent or LED display panel for displaying various items of information to a user of machine 10, such as feedback to the user of the selection made, the amount tended, and if the article is sold out or being vended. For accepting payments, a bill acceptor slot 26 accepts paper money into a conventional bill acceptor mechanism (mounted inside machine 10 so as to have its user interface portion extend through an opening 19 in flat section 20) for purchasing articles or for making change. A coin insertion slot 28 accepts coins into a conventional coin changer (also mounted inside machine 10 so as to have its user interface portion extend through opening 19) for purchasing articles or for making change. A coin return actuator 30 comprises a conventional push-button mechanism for activating a coin return portion of the coin changer mechanism which, upon actuation returns coins inserted by the current user, to a coin return well 32. The coin return portion of the coin changer mechanism also provides change to the coin return well 32 either in response to the purchasing of articles or for making change for paper money or larger coins. A credit/debit card slot 34 accepts a plastic credit/debit card inserted into a conventional card reader mechanism (also mounted inside machine 10 so as to have its user interface portion extend through opening 19) for allowing a user to pay for purchases via credit/debit cards. A door handle/lock mechanism 36 enables front door 14 to be secured so that it cannot be opened without a key. For allowing user selections, display panel 18 may include graphics, as noted above, which indicates the various articles vendible by the machine, as well as their associated price and a unique selection number. A conventional keypad push-button mechanism 38 is provided for enabling a user to select a desired article from vending machine 10. Alternatively, push-button mechanism 38 could include an individual push button for each article selection, as well known. In a further embodiment a user operated touch screen could replace pushbutton mechanism 38 and display 24. Although not shown in FIG. 1, machine 10 also includes a conventional telecommunications component that can be used for authenticating credit card purchases, as well as other uses relating to machine control and reporting the inventory and operational status of machine 10 to a remote location, as well known to those of ordinary skill in this technology.

Although vending machine 10 is illustrated to include the above described user interface components, in a more minimal embodiment useful with the present invention, most, if not all, of these user interface components could be omitted, and the dispenser could in fact be controlled from a remote location, with or without a local payment system.

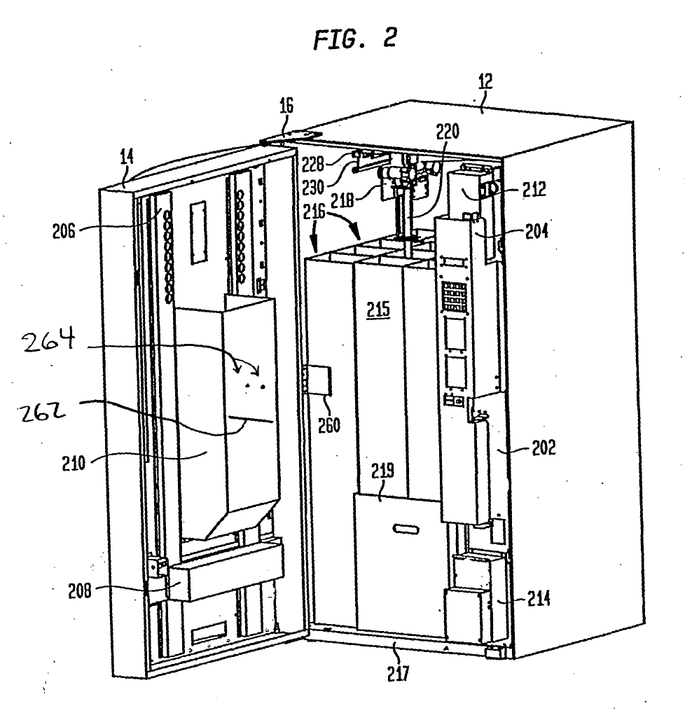

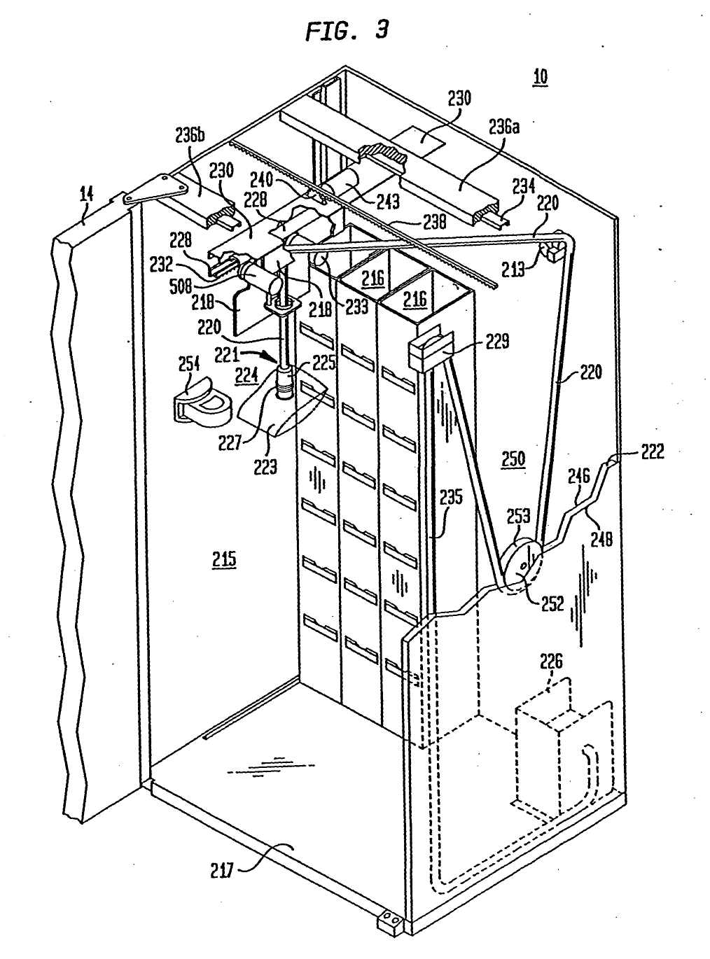

FIG. 2 is front perspective view of the vending machine of FIG. 1, with the front door open, so as to illustrate the main mechanical and electrical components therein. FIG. 3 is a somewhat idealized version of the main components of the article handling mechanism portion of vending machine 10, and is useful for understanding its general operation. Note, some portions of vending machine 10 are shown in these FIGURES cut away in order to better illustrate the interior components.

As shown in FIG. 2, the right portion of the front of cabinet 12 includes a vertically mounted support panel 202, which is used for mounting most of the user interface components. A hinged mounting bracket 204 is mounted on panel 202 and aligned with an opening in door 14 so that the user interface components, such as the selection button keypad 38, coin insertion slot 30, bill acceptor slot 28, coin return 32, and customer display 24, are all accessible to the user from the front side of door 14. Mounted on the interior of front door 14 are two fluorescent bulb light sources (not shown) that emit light for backlighting panel 18. The fluorescent bulb light sources are behind protective covers 206 so as to provide security (vandal protection), which is desirable as a result of the slot openings (not shown) in the structure of door 14 which allow for insertion of the fluorescent bulbs. Also mounted on the interior of front door 14 is a article delivery chute 210, and a ballast 208 for supplying power to the fluorescent bulbs. Note, the article delivery chute 210 is unconventional in that it is extremely tall, and therefore serves as a security measure to help prevent unauthorized access into the machine by insertion of an arm or other grasping mechanism into the customer retrieval area 22 from the exterior side of the machine. In typical prior art vending machines, a swinging security door is usually found in chute 210, which swings into a vandal blocking position when the customer pushes in the swinging door at the entrance to the article retrieval area 22. In a further embodiment of vending machine 10, such a swinging security door could be used in conjunction with article delivery chute 210, especially if chute 210 is not as tall as the one illustrated in FIG. 2 and also if the article retrieval area 22 is located higher up on machine 10. Mounted behind hinged mounting bracket 204 is a conventional bill acceptor mechanism for causing paper money inserted into bill acceptor slot 28 to be drawn into vending machine 10, a conventional coin changer which accepts coins inserted into coin insertion slot 28 and supplies coins to coin return well 32, a magnetic card reader, and a conventional bill validator which ascertains proper insertion of paper money into bill acceptor slot 28.

The interior of cabinet 12 substantially comprises a storage area 215, wherein a plurality of a vertically aligned bins 216 having open tops, store therein stacks of articles to be vended. Although in the illustrated embodiment a robotic article dispenser comprising a suction gripper at the free end of a suction hose 220 (shown more clearly in FIG. 3 as 224), is used to dispense the stored articles, such type of mechanism is not required for the present invention, and in fact any type of dispensing mechanism could be used which would be able to retrieve articles from aligned columns. In the illustrated robotic dispenser, a hose positioning mechanism is coupled to the suction hose 220, and comprises: a carriage 218 which includes a driven “pinch roller” aligned for driving hose 220 in the vertical (Z) direction, a beam 230 from which carriage 218 is slidably suspended and adapted for motorized movement therealong (in the front/back “Y” direction); and a slider arrangement (not shown) mounted in the left/right “X” direction at the top underside of cabinet 12, to which beam 230 is slidably suspended therefrom and adapted for motorized movement therealong. In the operation, a blower motor (not shown) provides suction to said hose 220, and the hose positioning mechanism controllably positions hose 220 to enter a selected bin 216, contact and become secured to an article at the top of the stacked in the bin, remove the selected article and position the article in the delivery chute 210. As noted above, although a robotic dispenser is described herein, it will be clear that the principles of the invention are not particular to any type of dispenser nor its dispensing arrangement and thus a gravity feed or article grasping claw-type dispenser, to name just two types of dispensing arrangements, could alternatively be used.

A control board 212 is mounted on panel 202 and comprises a printed circuit board on which circuitry is formed and to which integrated circuit chips are attached. A power supply 214 is also mounted on panel 202 and supplies power for the electrical components of vending machine 10. Control board 212 includes a microprocessor that is electrically connected to various sensors, hose positioning motors, the above described user interface elements, as well as other devices within vending machine 10, to control the operation of vending machine for dispensing articles, in a manner that is well known to those of ordinary skill in this technology. Accordingly, further description of the construction and operation of the remainder of the basic electrical components/functioning of the vending machine is believed to not be necessary.

Referring now also to FIG. 3, it is apparent that the bulk of the interior of cabinet 12 is available as an article storage area 215. Storage area 215 includes a plurality of vertically aligned article storage bins 216 arranged on the interior floor 217 of cabinet 12. In a refrigerated environment for the present invention the bins could be arranged to sit on a shelf positioned above the refrigeration system. Bins 216 are specifically designed for supporting and storing fragile articles 223 to be vended by machine 10. Further details relating to bins 216 are known, for example, by the additional text and Figures of the forenoted PCT Publication WO 02/01525, which is incorporated herein by reference.

An open-top container 219 (shown in FIG. 2) is dimensioned to hold a plurality of article storage bins 216 therein, and used, for example to facilitate the simultaneous handling (i.e., removal, installation and transportation) of the plurality of bins 216 into/out of the article storage area 215. Container 219 also facilitates rapid and accurate positioning of a plurality of the article storage bins into the storage area of the article handling apparatus. More specifically, the individual article storage bins can be pre-filled with fresh article and prearranged within the container 219 at a warehouse, and transported by the operator to the vending machine in order to rapidly, efficiently, and without error replace all or substantial all of the inventory of the vending machine by merely exchanging a new container 219 with the old container 219 presently in the machine. The removed container 219 can then be replenish with fresh articles by the operator back at his truck or at a warehouse, and then used for swapping/replacement in a subsequent vending machine. This “swapping” technique facilitates rapidly, efficiently, and without error changing all or part of the layout of the article selections, i.e., commonly called the “plan-o-gram”, of the vending machine. The present invention provides various methods and apparatus that improves upon the basic technique of using container 219.

The forenoted carriage 218 portion of the article handling apparatus (which carriage may be more generally referred to as an X-Y or planar positioning mechanism) is coupled to the interior topside of cabinet 12 and adapted for being controllably positioned by the control board portion 212 of machine 10, to a location centered over (so as to be aligned with) the open top-end, i.e., dispensing end, of a selected one of article storage bins 216.

Although vertical (Z-axis) alignment of the article storage bins 216 is shown, non-vertical, i.e., slanted or even horizontal (X or Y axis) alignment may also be possible (such as found in the well know glass front vending machines of the type using a “spiral wire” type of dispensing apparatus). In the event of substantially horizontal alignment of the storage bins, the planar positioning mechanism will be appropriately changed so as to position carriage 218 for movement in the X/Z or Y/Z plane. In fact, a curvilinear plane, such as a cylinder, is also considered to be within the scope of the present invention.

Use of a curvilinear plane for article transport is also known, for example in the videocassette vending art, wherein the videocassette's are stacked in an outwardly facing manner in a central storage carousel, and a robotic gripper encircles the carousel. Such a curvilinear plane for the article storage area is also compatible with the present invention. Furthermore, although article storage bins 216 are shown to be an ambient environment, bins 216 could in fact the positioned in a refrigerated environment, such as a freezer located in the bottom of storage area 217, and the article transport mechanism can enter the bins from a top opening in the freezer, such as shown and described in the forenoted U.S. Pat. No. 5,240,139. Alternatively, in the event the refrigerated environment is of the type including a substantially horizontal alignment of the storage bins, a vertically oriented opening could be used to provide access to the dispensing end of the article storage bins. Even furthermore, the entire storage area can be refrigerated, rather than use of a separate thermal area, such as a freezer mounted therein.

As shown more clearly in FIG. 3, an air hose 220 is continuous from a point before it's exit from a hose storage area 222 over orthogonally positioned rollers 213 (or other low-friction arrangement), to its free end 221. Free end 221 includes a weighted portion 225 in combination with a bellows extension tip portion 227. Depending upon the physical characteristics of the articles to be dispensed, article pickup head 224 may comprise only the weighted portion 225, or this portion in combination with a fitting specifically adapted to the type of packages to be dispensed, such as the bellows tip 227 (serving as an active suction cup) or a compliant tip without a weight. Hose 220 has one end coupled to a source of negative air pressure, i.e., suction, which source of suction comprises in the preferred embodiment a blower motor 226, and a free end coupled to the article pickup head 224. In the present description, the word continuous is intended to mean a hose which is connected and acts between it's end points, in order to accomplish the functions required by it, as a unitary/single hose, i.e., one than one hose can be coupled together to act as a single hose. Such a continuous hose is not required for the present invention, but using one allows for a compact article grasping arrangement.

An air hose portion 235 provides suction from blower motor 226 to one port of an air junction box 229, while continuous hose 220 is connected to a second port of air junction box 229. Air junction box 229, included at a top portion of hose storage area 222, includes an airflow sensor and vacuum breaker assembly. The airflow sensor is used to develop a signal that is applied to the controller of the vending machine and is representative of the airflow through air hose 220. The vacuum breaker assembly is used to quickly bring the air pressure in hose 220 to the ambient pressure, thereby facilitating a “quick-release” of an article transported by the article pickup head, into the dispensing chute 210. It is noted that a quick release of the articles does not have to occur at the top of dispensing chute 210, and in the event that it is desirable to avoid subjecting the article to forces which result from jarring or dropping, the article pickup head could proceed to the bottom of the dispensing chute 210 before providing release of the article, with or without the use of the quick release valve. In one embodiment, the airflow sensor arrangement may comprises a two-part switch, a first part includes a reed switch mounted on a top portion of box 229, and a second part includes a magnet mounted at the free end of a swinging arm mounted inside box 229. As the arm swings inside box 229 due to changes in airflow, the switch is “toggled”, thereby indicating changes in airflow. The use of this airflow signal will be described in greater detail later. In an alternative embodiment, the functions of the airflow valve and quick release could be built into the blower motor enclosure, or they could be eliminated entirely. With this arrangement, hose 220 would be continuous from the picker head all of the way to the blower motor.

A clever hose positioning arrangement is provided for aligning carriage 218 with a selected one of bins 216. This alignment is accomplished in the front/back (Y) direction using a front/back linear slide 228 (shown in a cut away view) mounted to an “L” shaped front/back beam 230 so that carriage 218 can be controllably positioned therealong using slide 228. A bottom edge portion of beam 230 includes a rack portion 232 and carriage 218 includes an electric motor 233 that drives a gear (not shown) which engages rack portion 232. Application of forward and reverse motor control signals from control board 212 to motor 233 causes carriage 218 to be driven in the front/back directions. Alignment of carriage 218 in the left/right (X) direction is accomplished in a similar manner, using a left/right linear slide 234 which slidably couples the top side of front/back beam 230 to the underside of each of spaced apart left/right beams 236a and 236b. Beams 236a and 236b are rigidly attached to the inside top portion of cabinet 12. A rack 238, also rigidly attached to the top inside portion of cabinet 12 and in parallel with beams 236, is engaged by a gear 240 driven by a reversible motor 243 mounted near the inside corner of beam 230. Application of forward and reverse motor control signals from control board 212 to motor 243 causes a rotation of gear 240 and a corresponding movement of beam 230, and hence carriage 218, in the left/right (X) directions.

Note that although carriage assembly 218 only moves in a single plane (which in the illustrated embodiment is illustrated as being horizontal), it is responsible for precisely positioning pickup head 224 in each of the X, Y and Z directions. More specifically, carriage 218 includes a roller arrangement (not specifically shown, but which may comprise three orthogonally positioned rollers at the point where hose 220 enters carriage 218) for redirecting the movement of hose 220 from the substantially horizontal direction along the top interior portion of machine 10 (i.e., in the X,Y direction), to a direction perpendicular thereto (i.e., in the Z direction). Thus, movement of carriage 218 will move the article pickup head 224 at the free end 221 of hose 220 so that it can be aligned with the longitudinal axis of a selected one of bins 216. Thereafter, a hose drive mechanism (not specifically shown, but which may comprise a set of conventionally operated “pinch rollers” carried by carriage 218), is driven by a reversible motor 508 for driving pickup head 224 into/out of the selected bin 216 in order to retrieve articles stored therein. In the illustrated embodiment the hose drive mechanism is mounted in carriage 218, but in a further embodiment motor 241 and the pinch rollers, or some other drive mechanism, such as an articulated arm, could be mounted so as to act somewhere else along the length of hose 220 so as to enable driving of pickup head 224 into/out of a selected bin 216.

This arrangement, where hose 220 travels in the same X,Y plane that carriage 218 travels, facilitates a compact hose positioning and drive mechanism embodiment.

Since hose 220 is formed of a continuous material from its connection to the source of suction at one end (which connection in the illustrated embodiment is at the vacuum junction box 229) to the pickup head 224 at its other end, means are necessary for providing hose storage and/or retraction during travel of the pickup head 224 in the X, Y and Z directions during the article dispensing operations.

A hose storage area 222 is formed by placing an interior wall 246 parallel and adjacent to an exterior wall 248 of cabinet 12. Walls 246 and 248 are shown in FIG. 3 as partially cut-away so as to illustrate a gravity feed self-retracting loop 250 in hose 220. Loop 220 is constrained for movement within hose storage area 222, and made self retracting by providing a rolling weight 252 having a groove 253 along its periphery in order to provide constant centering of the weight within hose storage area 222 and providing a constant “loop forming” tension on hose 220. Furthermore, centering of the grooved rolling weight 252 within hose storage area 222 results in centering of hose 220, thereby preventing hose 220 from rubbing with the walls of hose storage area 222 during X,Y and Z repositioning of pickup head 224. In order to prevent binding of hose 220, rolling weight 252 is dimensioned so as to be slightly larger than the diameter of hose 220 and the width dimension of hose storage area 222 is dimensioned to be only slightly larger than the width dimension of rolling weight 252.

It is also noted that this gravity-based retraction/hose storage technique meets the storage requirements needed for both the X and Y movements of carriage 218 (left/right and front/back), as well as for the Z movement of pickup head 224. Of course this gravity-based retraction/hose storage technique would work equivalently well in an embodiment wherein the robotic hose positioning mechanism used a rotary type device (R, 0), an articulated arm, telescoping or scissor system, or other technique. Furthermore, the illustrated gravity-based retraction/hose storage technique is not necessary for the present invention, and in fact a fully or partially motorized retraction technique could also be used. Furthermore, in other embodiments, it may be desirable to place hose storage area at another location, such as parallel to the top or rear portion of cabinet 12.

In the environment of the present invention, it is noted that FIGS. 2 and 3 also illustrate that as the hose positioning arrangement causes an article 223 to be moved by pickup head 224 from a storage bin 216 to chute 210, it is positioned past an article identification (ID) device 254 mounted within cabinet 12. Although an article ID device is not required for the present invention, depending upon system requirements, such a device may be used. The ID device may comprise, for example, a bar code scanner or other optical image/pattern recognition system, or even a non-optical system, such as a radio frequency identification (RFID), or magnetic-based system mounted within cabinet 12, for uniquely identifying and confirming that the article being dispensed is in fact the article that was selected.

Such article or bar code recognition uniquely identifies the transported article to control board 212, and can be used for inventory management, as well as operational control of vending machine 10.

A bin holder 260, shown in FIG. 2, comprising in the illustrated embodiment a pair of rectangular brackets 260 secured in a spaced manner to opposed interior side walls of cabinet 12, is used to maintain the bins situated therebetween in a predetermined position relative to the interior of the vending machine cabinet. This is useful in view of the pre-programming of control board 212 so that the controller knows the precise X-Y position of each bin, and can thereafter control the robotic structure so as to allow it to correctly retrieve a selected article from a predetermined one of bins 216.

As described above, positioned inside storage area 215 are a plurality of axially aligned article storing bins 216.

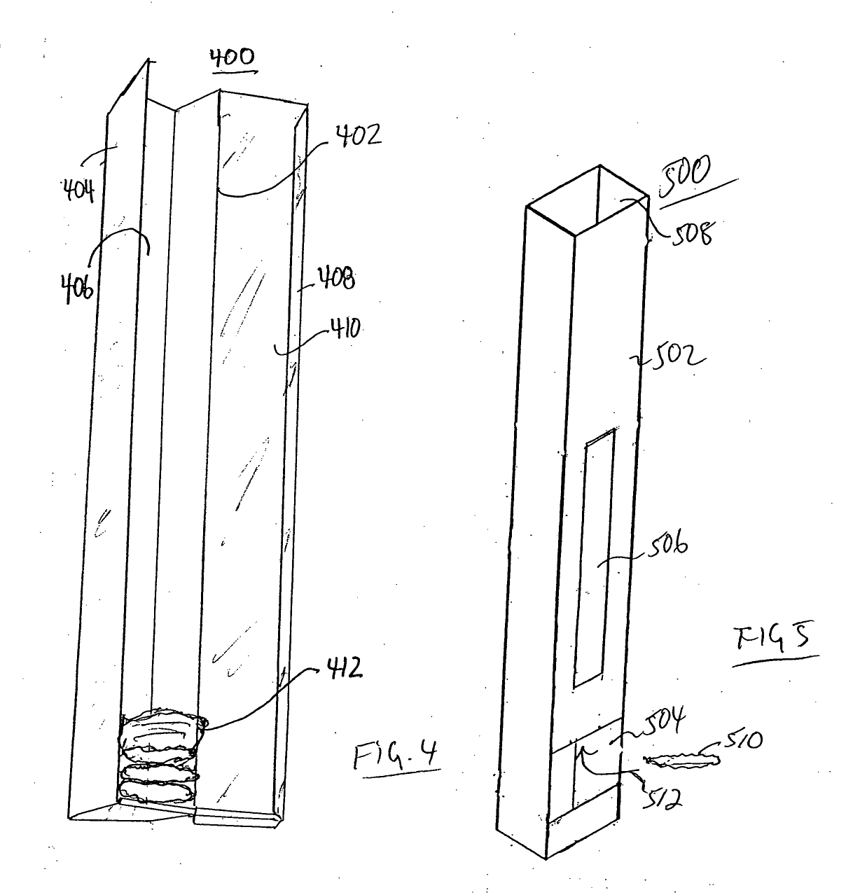

Referring to FIG. 4, a prior art article storage bin and a bin loading technique is illustrated. FIG. 4 shows a bin 400 of the type formed by folding, for example, a corrugated material such as a plastic or paper based product, along a hinge line 402, so as to form two halves of an elongate rectangular cross-section article storage bin 400. One half 404 forms a U-shaped article holding trough 406, and a second half 408 forms a U-shaped hinged lid 410. In operation, trough 406 is loaded with articles 412 to be vended, and after it is filled with articles, the hinged lid 410 is moved to a closed position. In the closed position, lid 410 covers the open side of trough 406 so that half 404 becomes nested within half 408, thereby securely holding the articles 412 loaded therein. When the two halves are nested together, they form the elongate rectangular article storage bin 400.

One disadvantage of this apparatus is that no mechanism is provided to encourage a FIFO re-loading of the articles into the bin. A further disadvantage of this apparatus is that the top left corner of the article packaging may get “pinched” if due care is not exercised when the two halves of the bin are nested together. More specifically, a corner of the packaging of an article inside the bin can get “stuck in place” at the point where the distal end of half 406 meets the meets half 408 so as to form an inside corner of bin 400. Additionally, when an articles is being transported up the bin during article dispensing, it is possible that the top left corner of the article packaging may get “pinched” at this inside corner formed by the nesting together of the two halves. Such pinching could also lead to a “stuck in place” article, and hence a failed dispensing of the article from the bin.

One way to encourage a FIFO re-loading of the articles into the bin would be to only provide an opening at the bottom of the bin. Of course, there would have to be an opening at the top of the bin, but this opening would not be useful for reloading the bin with fresh articles, since if inserted from the top, the articles could tumble, twist or turn on their way down inside the bin, and then fail to present a uniform facing stack of articles necessary for ensuring a high packing density, as well as presenting a uniform surface to help ensure a good grasp by the article extraction device.

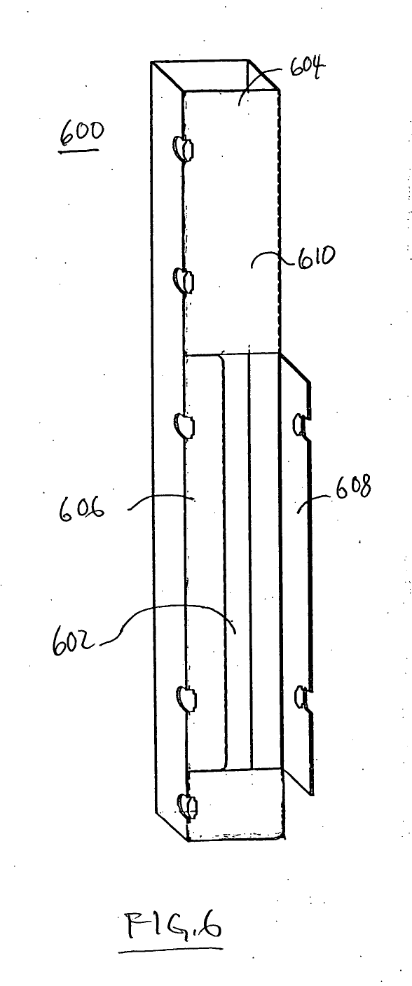

FIG. 5 illustrates a prior art bin 500, where a sidewall 502 includes openings 504 and 506. In operation, since retrieval of products is from the top 508 of the bin, loading of the bin must take place from the bottom in order to preserve a first-in, first-out (FIFO) product dispensing. Accordingly, the service person will insert the articles 510 into the relatively wider opening 504 at the bottom of bin 500 and then using his hand, push them upward in the bin 500, as shown by the arrow 512. Opening 506 is provided to assist movement of the inserted articles 510 towards the top 508 of bin 500. It is noted that the article supporting tabs described in the prior PCT publication incorporated herein by reference, could be used to support some of the weight of the articles position in the bin, and encourage FIFO reloading.

Although the openings 504 and 506 assist with the FIFO refilling of the article storage bins, one problem that is encountered is that the edges of the openings, particularly opening 504 may have a tendency to snag on the edges of certain types of packaging used with the stored articles, such as the flexible packaging used to hold potato chips. Such snagging can cause the article handler to malfunction and/or drop the article trying to be retrieved. Additionally, the presence of the openings 504 and 506 tend to weaken the structural integrity/rigidity of the bins. It would be desirable to maintain the advantages provided by openings 504 and 506, without weakening the structural integrity/rigidity of the bins. Additional advantages are also desirable, such as a wider opening so that reloading can take place more rapidly.

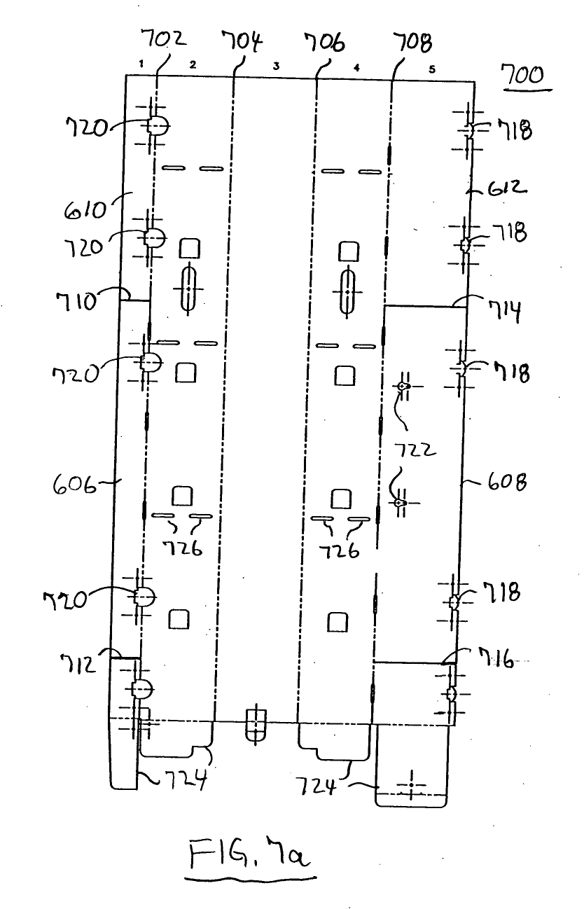

Accordingly, FIG. 6 illustrates an article storage bin 600 constructed in accordance with the principles of the present invention. Bin 600 is constructed in a manner that is basically similar to that described in detail for the prior art bins described in the forenoted PCT publication, except as now described. Furthermore, since the cutting, folding and forming of boxes is a well known craft, the following description will only describe the basic parts and the functioning thereof for bin 600, and further description of the details needed in order to cut, fold and form sheet material so as to result with bin 600 is not deemed necessary.

More specifically, in place of the article-loading openings 504 and 506 shown in FIG. 5 (which may disadvantageously present abrupt edges to a desired smooth movement of articles from inside the bin during a dispensing operation), a single article-loading opening 602 is formed in one side 604 of bin 600, and two flaps 606 and 608 are positioned for hinged operation along opposed longitudinal edges of opening 602 for closing opening 602. Article-loading opening 602 preferably has a width substantially the same as the width of side 604, so as to provide a quick and easy access port for loading of the bin with articles. Since the hinges of flaps 606 and 608 each form an inside longitudinal corner for bin 600, in spite of a full width article-loading opening 602 formed in side 604, smooth inside corners are presented to the articles stored in the bin.

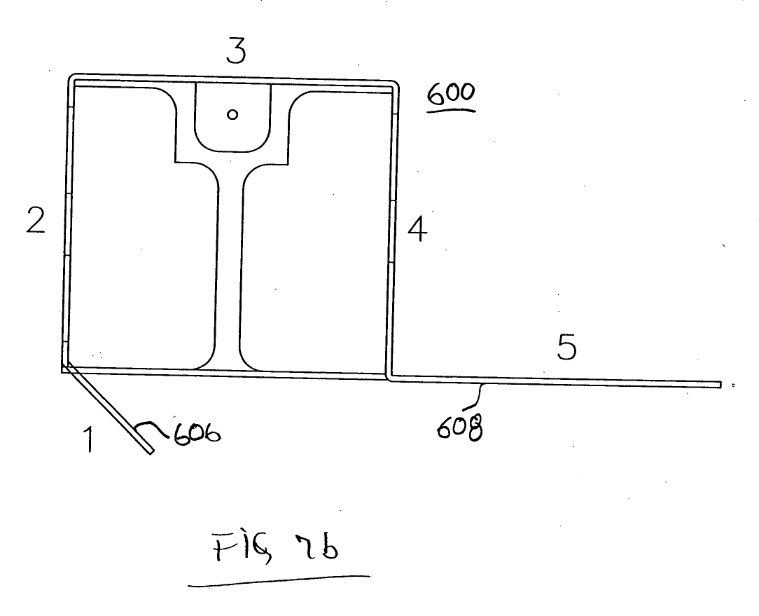

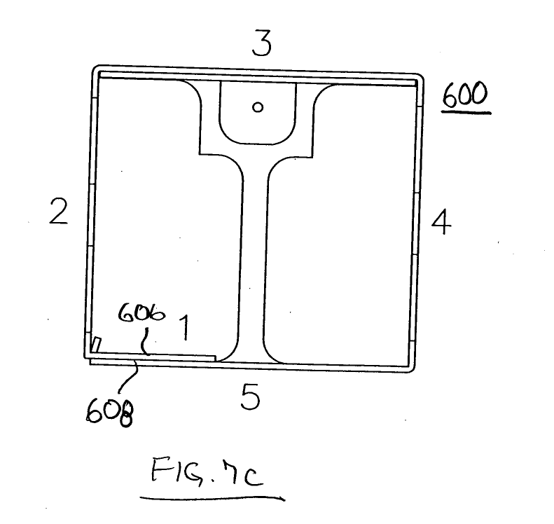

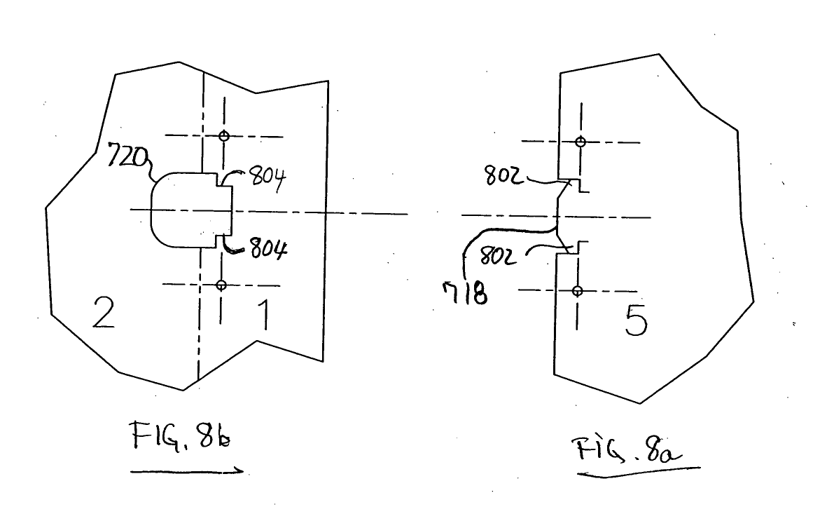

In one embodiment, bin 600 can be formed relatively inexpensively by die-cutting a single piece of sheet material, such a corrugated paper or plastic, and then folding the sheet material along preformed fold/crease lines so as to form the final shape as shown by FIG. 6. FIG. 7a illustrates such sheet material 700, as well as the fold lines 702, 704, 706, and 708 which produce after folding, portions 2, 3 and 4 (which form the left, back and right sides of bin 600), and portions 1 and 5 (which form the left and right flaps that complete the rectangular cross-sectional shape for bin 600). After such cutting, folding and forming, the elongate bin 600 results having, in the illustrated embodiment the rectangular cross-section as shown in FIG. 6 (but other cross-sections could also be used, as appropriate for a particular use, such as circular, etc.). FIGS. 7b and 7c illustrate a top view of the folded/assembled bin 600, shown with flaps in accordance with the invention that are initially open and then closed, respectively.

Opening 602 is formed by cut-lines 710 and 712 in portion 1, and cut-lines 714 and 716 in portion 5. These cut-lines also form flaps 606 and 608, respectively. Note, portion 1 has a width so as to allow flap 606 to cover at least a portion of the width of opening 602 when it is bent to a closed position, and portion 5 has a width so as to allow flap 608 to at least overlap with the distal longitudinal edge of flap 606 when it is bent to a closed position.

In the illustrated embodiment, flap 606 has a width that is less than the full width of opening 602, and flap 608 has a width so that its distal edge can extend up to the fold line 702 in the completed bin, i.e., so that it is substantially the same width as the full width of opening 602.

In the illustrated embodiment, tabs 718 are formed/cut into the distal edge of flap 608 and are used for securing flap 608 in a closed position by mating with appropriately positioned corresponding openings 720 formed in the sheet material along fold line 702. An enlarged illustration of the tabs 718 and openings 720 is shown in FIGS. 8a and 8b, respectively, where “wing” portions 802 of tabs 718 are dimensioned to form a friction fit inside opening 720. More specifically, “wing” portions 802 of tabs 718 form a friction fit with projections 804 in openings 720, when the tabs 718 are bent so as to protrude into the openings 720. Due to the sturdy but flexible nature of the sheet material 700, the latch formed by this tab/opening arrangement makes a secure closure of flap 608 over flap 606. Advantageously, this closure is both reliable and re-usable. Other shapes for the tabs/openings that form the latchable closure arrangement are possible, and are merely a matter of design choice. Making the latch using the sheet material itself provides a particularly low-cost closure arrangement, although in a further embodiment of the invention, additional devices could be used to form a reusable closure, such as one using clips or other friction/clamping devices.

When both of flaps 606 and 608 are closed they provide smooth sidewalls along the longitudinal and lateral edges of opening 602, both inside and outside of the bin. Such smooth sidewalls also help form smooth corners along the inside of the bin. The smooth inside corners and sidewalls assist significantly with the reliable longitudinal movement of articles along the inside of bin 600 during the dispensing operation. On the outside of the bin, closure of flap 608 provides a smooth surface for the front face (portion 5) of bin 600, thereby facilitating easy positioning of the bins 600 into and out of a container used for simultaneous repositioning of a plurality of bins 600 into and out of the storage area of a vending machine, such as shown in FIG. 2 using the macrobox 219. Furthermore, due to the overlap of flap 606 by flap 608, significant structural integrity and rigidity of the bin 600 is maintained, even though a substantial opening 702 is provided in a majority portion of the side formed by portion 5. Such structural integrity and rigidity for the bins 600 is particularly important in the event that during their usable life they are routinely placed into and removed from macrobox's 219 during article refilling of the vending machines.

As noted above, in order to assist with FIFO dispensing of the articles in bin 600, it is desirable to form opening 602 in a lower portion of the bin, so that during reloading of the bin with fresh articles, the articles can be inserted at the lower end of the bin and pushed upward, however, in order to help maintain the structural integrity and rigidity of the bin 600, opening 602 should not extend all the way to the bottom end of the bin, and instead to just near the bottom, as shown in FIG. 6.

Note, in the event it may be desirable to be able to fully open bin 600, so as to provide an opening such as shown for bin 400 of FIG. 4, the upper part of portions 1 and 5 of bin 600 includes corresponding tabs 718 and openings 720 such as used for making the reusable closures for flap 608, for forming separately operable flaps 610 and 612. In a similar manner, these flaps form smooth surfaces for the top portion of bin 600 when they are closed, but allow full access to the inside of bin 600 when they are opened in conjunction with flaps 606 and 608. Alternatively, if an upper opening is not particularly needed, and instead a more rugged bin is desired, flaps 610 and 612 could be more permanently secured to each other using, for example, a clip, staple, rivet, or other binding device. In one embodiment, rivets are passed through the accessory holes (shown, but not numbered) that are positioned on opposite sides of the tabs 718 and openings 720, for securing flaps 610 and 612 together in a more permanent and secure manner.

Please note that FIG. 7a also shows openings 722 in cover flap 608. These openings are useful to co-act with a latch or other projection having a fixed position, so as to hold flap 608 in an open position to facilitate refilling of the bin with more articles to be dispensed. More specifically, although not shown in detail in FIG. 2, an inclined lip or shelf 262 could be positioned inside door 14, for example on an inside facing surface of chute 210 shown in FIG. 2. Appropriately positioned above shelf 262 are two projections 264 which mate with openings 722 in cover flap 608, so as to releasable hold the flap open while the service person refills the bin with fresh articles. In the illustrated embodiment, the openings 722 have a shape which will releasable mate with a pin 264 having a step change in its diameter, so as to selectively restrain flap 608 in an open position when the projections are fully positioned inside the openings 722. Once the bin is refilled, the service person merely has to slightly raise the bin so as to lift the flap off of the pins 264, close the flap 608 over the opening using the latches 718 previously described, and then replace the bin in the storage area. In a further embodiment, pins 264 could comprise any kind of restraining device, such as a hook, velco® etc.

Note also that a plurality of slots 726 are also illustrated as being cut into sheet 700. Slots 726 are intended to be used for installing article supporting tabs, such as described in the forenoted PCT publication, which tabs help support the weight of articles stored in the bin, and thereby help prevent the weight of the articles that are higher up in the bin from crushing or otherwise damaging articles that are positioned lower in the bin. As described in forenoted PCT publication, the tabs are flexible and biased so as to present an insignificant obstruction to the passage of articles toward the open dispensing end of the bin, but to not be flexible and help prevent movement of the articles in a direction opposite to the dispensing direction.

In a further embodiment, instead of using folded flaps 724 to form a bottom for bin 600, the bottom may merely comprise an opening, it may comprise a pair of article supporting tabs as described in the forenoted PCT publication, or even one large flexible or selectively removable tab which has a shape substantially similar to the cross-sectional shape of bin 600, in order to help bin 600 keep its rectangular shape.

It is intended that the present invention not be limited to the described embodiments, but that it has the full scope defined by the above descriptions and alternatives, as well as equivalents thereof.

1. An article storage container, comprising
a multi-sided enclosure forming a bin for storing in a columnar manner, articles to be dispensed from inside of the bin, one side of said enclosure having a longitudinal article-loading opening of a given width therein;
a first flap hinged along a first longitudinal edge of the article-loading opening, and a second flap hinged along a second longitudinal edge of the article-loading opening which is opposed to the first longitudinal edge of the article-loading opening; wherein,
the first flap has a width dimensioned so as to cover at least a portion of the given width of the longitudinal article-loading opening when the first flap is bent to a closed position, and the second flap has a width dimensioned so as to at least overlap with the distal longitudinal edge of the first flap when it is bent to a closed position so as to cover any remainder portion of the given width of the longitudinal article-loading opening which is not covered by the first flap.

2. The article storage container of claim 1, wherein the first flap has a width dimensioned to be less than the full width of the longitudinal article-loading opening, and the second flap has a width dimensioned so that its distal edge can extend completely across the given width of the longitudinal article-loading opening.

3. The article storage container of claim 1, wherein the multi-sided enclosure forming the bin is formed by folding and cutting a single piece of sheet material, so as to form a final shape for said bin.

4. The article storage container of claim 1, wherein the single piece of sheet material comprises one of corrugated paper or plastic.

5. The article storage container of claim 1, wherein one of said first and second flaps has a latch opening therein located near the first longitudinal edge of the article-loading opening, and the other of said first and second flaps has a tab portion formed at its distal end, which tab co-operates in conjunction with said latch opening so as to form a selectably releasable latch which can selectively hold the said first and second flaps in a closed position over the longitudinal article-loading opening.

6. The article storage container of claim 5, wherein:
said tab portion includes opposed tab projections that extend outward from a central tab portion, and said latch opening includes opposed latch projections that extend inward from the periphery of an opening, the opposed projections of at least one of said central tab portion or opening being flexible; and
the dimensioning of the opposed projections of said central tab portion and said latch opening being such that a friction fit of the opposed tab projections can be established between the opposed latch projections so as to hold the first and second flaps in said closed position.

7. The article storage container of claim 1, wherein said articles are dispensed from inside the bin by passing the dispensing end in a direction opposed to gravity.

8. An article dispensing apparatus, comprising:
a storage area for storing articles along at least one longitudinal axis in an article storage bin;
an article extracting device including an end for selectively extracting an article from a dispensing end of the article storage bin; and
a drive mechanism coupled to the article extracting device for moving the end thereof into and then out of the dispensing end of the article storage bin and in a direction aligned with the longitudinal axis in the article storage bin, in order to extract a selected article from inside the article storage bin;
wherein said article storage bin comprises:
a multi-sided enclosure forming a bin for storing in a columnar manner, articles to be dispensed from inside of the bin, one side of said enclosure having a longitudinal opening of a given width therein;
a first flap hinged along a first longitudinal edge of the opening, and a second flap hinged along a second longitudinal edge of the opening which is opposed to the first longitudinal edge of the opening; wherein,
the first flap has a width dimensioned so as to cover at least a portion of the given width of the longitudinal opening when the first flap is bent to a closed position, and the second flap has a width dimensioned so as to at least overlap with the distal longitudinal edge of the first flap when it is bent to a closed position so as to cover any remainder portion of the given width of the longitudinal opening which is not covered by the first flap.

9. The article dispensing apparatus of claim 8, wherein the first flap has a width dimensioned to be less than the full width of the longitudinal article-loading opening, and the second flap has a width dimensioned so that its distal edge can extend completely across the given width of the longitudinal article-loading opening.

10. The article dispensing apparatus of claim 8, wherein the multi-sided enclosure forming the bin is formed by folding and cutting a single piece of sheet material, so as to form a final shape for said bin.

11. The article dispensing apparatus of claim 8, wherein the single piece of sheet material comprises one of corrugated paper or plastic.

12. The article dispensing apparatus of claim 8, wherein one of said first and second flaps has a latch opening therein located near the first longitudinal edge of the article-loading opening, and the other of said first and second flaps has a tab portion formed at its distal end, which tab co-operates in conjunction with said latch opening so as to form a selectably releasable latch which can selectively hold the said first and second flaps in a closed position over the longitudinal article-loading opening.

13. The article dispensing apparatus of claim 12, wherein:
said tab portion includes opposed tab projections that extend outward from a central tab portion, and said latch opening includes opposed latch projections that extend inward from the periphery of an opening, the opposed projections of at least one of said central tab portion or opening being flexible; and
the dimensioning of the opposed projections of said central tab portion and said latch opening being such that a friction fit of the opposed tab projections can be established between the opposed latch projections so as to hold the first and second flaps in said closed position.

14. The article dispensing apparatus of claim 8, further including a bin support mounted adjacent said storage area for supporting said bin in substantially a horizontal position in order to facilitate opening of said first and second flaps and refilling of said bin with articles.

15. The article dispensing apparatus of claim 14, further including a latch arrangement for holding one of said first and second flaps in an open position while said bin is positioned on said bin support.

16. The article dispensing apparatus of claim 8, wherein said articles are dispensed from inside the bin by passing the dispensing end in a direction opposed to gravity.
